(19) United States
(12) Patent Application Publication
(10) Pub. No.: US 2008/0002758 A1
(43) Pub. Date: Jan. 3, 2008

(54) COMMUNICATIONS DEVICE AND METHOD FOR CHANGING UTILIZATION DATA

(75) Inventors: Andreas Schmidt, Braunschweig (DE); Norbert Schwagmann, Braunschweig (DE); Achim Luft, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/770,335

(22) Filed: Jun. 28, 2007

Related U.S. Application Data
(60) Provisional application No. 60/806,068, filed on Jun. 28, 2006.

(51) Int. Cl. H04B 1/69

(52) U.S. Cl. 375/130

(57) ABSTRACT

A communications device having a receiver device which, via a communications network, is configured to receive first change data which specify a change in utilization data which describe the setting of a communications terminal within the scope of the use of an ad hoc communications network, and a transmitter device which, via the ad hoc communications network, is configured to transmit second change data which specify the change.

### CROSS-REFERENCE TO RELATED APPLICATION

This application claims priority to Provisional Patent Application Ser. No. 60/806,068, which was filed Jun. 28, 2006, and is incorporated herein by reference in its entirety.

### FIELD OF THE INVENTION

The invention relates to a communications device, a method for transmitting data, a communications terminal and a method for changing utilization data.

### BACKGROUND OF THE INVENTION

Bluetooth technology is being increasingly used for local networking of small mobile communications terminals such as, for example, mobile phones and PDAs (personal digital assistants) as well as for communication between computers and peripherals (for example a mouse or a keyboard). Bluetooth is an industry standard for wireless networking of electronic devices over a relatively short distance by means of radio.

Recently, Bluetooth technology has also been increasingly used in the automobile industry. For example, acoustic or visual input and output devices or operator control elements (such as for example a microphone, a loudspeaker, displays or keys), which are permanently integrated in a car, are coupled in a wireless fashion to a mobile phone using Bluetooth. A car driver can use the input and output devices and operator control elements in the car to make a telephone call and the mobile phone itself no longer has to be operated directly and can, for example, remain in a user's coat pocket during the car journey.

The Bluetooth SIG Conference is currently discussing providing, in addition to the transmission technology which is currently used and has been proven for Bluetooth and with which download speeds of up to 2.2 Mbit/s can be achieved, also one or two further transmission technologies for Bluetooth, with which considerably higher data transmission rates can be reached.

One of these two transmission technologies is to operate in the UWB (Ultra Wide Band) frequency band in accordance with the standard of the WiMedia Alliance and permit data transmission rates of over 1000 Mbit/s.

At present, WLAN in accordance with IEEE 802.11 and the UWB technology of the UWB forum are being increasingly discussed as further alternative transmission technologies. A decision about this has not yet been made. However, it is certain that at the Bluetooth SIG initial work is focusing only on the integration of the UWB transmission technology in accordance with WiMedia Alliance and work will be carried out on generic integration of further possible alternative transmission technologies only in a second step.

The UWB transmission technology in accordance with the standard of WiMedia Alliance is based on OFDM (Orthogonal Frequency Division Multiplexing). OFDM is used, for example, in digital video broadcasting (DVB), digital audio broadcasting (DAB), xDigital Subscriber Line (xDSL) and Power Line Communications (PLC). In the case of OFDM, a plurality of carrier signals are modulated and a signal is transmitted by modulating orthogonal carrier signals. Accordingly, in OFDM a datastream is divided into N-parallel datastreams (with a correspondingly lower data rate) and each of the N datastreams transmits by means of its own carrier signal. The orthogonality of the carrier signals is achieved by virtue of the fact that a specific minimum frequency spacing is maintained between the carrier signals. In contrast to FDM (Frequency Division Multiplexing), in the case of OFDM spectral overlapping of the carrier signals is permitted, as a result of which a significantly higher spectral efficiency than with FDM can be achieved. This advantage is greater the more carrier signals are used.

For example, transmission technologies which are based on, for example, DSSS (Direct Sequence Spread Spectrum) are possible as further alternative transmission technologies for Bluetooth.

DSSS is a frequency spread method for wireless data transmission in which a signal is spread by means of a predefined sequence. In this way, in DSSS the symbol energy is illustratively distributed over a wide bandwidth. A useful datastream is multiplied by a specified code whose data rate is higher than that of the useful datastream. This code is referred to as chip sequence or PN (Pseudo Noise) code sequence. As a result of the spreading of the useful datastream (that is to say as a result of the multiplication), a relatively large bandwidth is necessary for the transmission of the useful datastream. However, as a result of the spreading, the spectral power density is also reduced so that the (spread) signal which is used for transmission has a power density which is comparable with that of the background noise. As a result, the spread signal causes little interference with other signals. The original useful datastream can be reconstructed at the receiver of the spread useful datastream by using the chip sequence which is used for the spreading.

Code spreading is used in particular in the CDMA (Code Division Multiple Access) method. Here, each transmitter is assigned a uniquely defined chip sequence. In this way, all the transmitters can transmit simultaneously and a receiver can reconstruct the individual signals and differentiate the transmitters.

The transmission of data in accordance with DSSS is less sensitive to narrowband interference since interference signals in the receiver are also multiplied by the chip sequence. In this way, interference signals, just like the useful data signal at the transmitter, are spread and the power density of the interference signals is reduced, as a result of which the interference on the useful datastream is reduced.

DSSS is used, for example, in the global positioning system (GPS), in wireless local area networks (WLANs), in the UWB technology of the UWB forum, but also in mobile radio systems in accordance with the UMTS (Universal Mobile Telecommunication System) standard.

Consequently, it is conceivable that the WLAN technology in accordance with IEEE 802.11 and/or the DSSS-based UWB technology in accordance with the standard of the UWB forum will be used later for Bluetooth (as already mentioned above).

The two transmission technologies discussed for application in Bluetooth, that is to say the transmission technology which is based on OFDM and the transmission technology which is based on DSSS, both operate, as mentioned above, in the ultrawide band (UWB) which (in terms of the level of the frequencies) is significantly above the ISM frequency band currently used for Bluetooth. In contrast to the ISM frequency band, the UWB frequency band cannot be used without approval. So that interference is avoided, the maximum transmission powers for the entire UWB frequency band are defined individually throughout the world by regulating authorities on the basis of the respective national conditions. In many countries (or also regions), these maximum transmission powers are defined definitively in the form of frequency masks (that is to say a maximum transmission power for each frequency of the UWB frequency band is defined including the maximum permitted deviation), but there are also countries in which this has not yet been done.

Worldwide use of the UWB frequency band is being further complicated by the fact that in some countries until now only the use of parts of the UWB frequency band for applications is permitted, but in future these parts will possibly also be extended. In many countries (or regions), the use of specific frequency regions in the UWB frequency band is also approved only on a time-limited basis.

The transmission technology which is based on OFDM currently has a greater chance of being used for Bluetooth than the other transmission technologies which may be based, for example, on DSSS. In accordance with WiMedia, the UWB frequency band in the range from 3.1 GHz to 10.6 GHz is divided into a total of 5 subgroups composed of a total of 14 subfrequency bands with the width of 528 MHz.

The maximum permissible transmission powers as a function of the frequencies in the UWB frequency band have been defined in the USA by the FCC (Federal Communications Commission) and in Europe by the CEPT (European Conference of Postal and Telecommunications Administrations). In Japan also, the maximum permitted transmission powers have already been defined but there are also regions (for example China and Australia) for which no maximum transmission powers have been defined yet. In the frequency range from 3.1 GHz to 10.6 GHz there are only two comparatively small frequency bands in which the maximum value of approximately −42 dBm/MHz is permitted as a transmission power in the USA, in Europe and in Japan.

The current practice of regulating authorities of defining the maximum permissible transmission powers with varied timing and of postponing decisions about which frequency ranges of the UWB frequency band are to be used and which maximum transmission powers are permitted to some indeterminate time is disadvantageous for the manufacturers of UWB communications modules, that is to say communications modules by means of which it is possible to transmit and receive in the UWB frequency band, and it is disadvantageous for the manufacturers of communications terminals in which UWB modules are to be used. In particular, this is disadvantageous for the manufacturers of Bluetooth modules if it is decided to provide a transmission technology which operates in the UWB frequency band for data transmission with Bluetooth.

In order to save development and manufacturing costs, a manufacturer of UWB modules will, if possible, already wish to have planning security in the design phase and, if possible, only manufacture UWB modules which permit the use of the entire permissible frequency band and can be used throughout the world without subsequent modifications being necessary. However, this runs contrary to the current decisions of the regulating authorities in the various regions of the world. If frequency ranges of the UWB frequency band are defined as permissible only on a time-limited or provisional basis (or else are defined as not permissible), UWB modules may already be outmoded after a short time or may, under certain circumstances, not fully exploit their full performance capability (if new frequency ranges are approved).

### SUMMARY OF THE INVENTION

A communications device is provided having a receiver device which, via a communications network, is configured to receive first change data which specify a change in utilization data which describe the setting of a communications terminal within the scope of the use of an ad hoc communications network, and having a transmitter device which, via the ad hoc communications network, is configured to transmit second change data which specify the change.

### BRIEF DESCRIPTION OF THE FIGURES

FIG. 1 shows a communications arrangement in accordance with an exemplary embodiment of the invention,

FIG. 2 shows a telecommunications flowchart in accordance with an exemplary embodiment of the invention,

FIG. 3 shows a communications arrangement in accordance with an exemplary embodiment of the invention,

FIG. 4 shows a message flowchart in accordance with an exemplary embodiment of the invention,

FIG. 5 shows a frequency mask in accordance with an exemplary embodiment of the invention, and

FIG. 6 shows a communications device in accordance with an exemplary embodiment of the invention.

### DETAILED DESCRIPTION OF THE INVENTION

In accordance with one exemplary embodiment of the invention, a communication device is made available having a receiver device which, by means of a communications network, receives first change data which specify a change in utilization data which describe the setting of a communications terminal within the scope of the use of an ad hoc communications network, and having a transmitter device which, by means of the ad hoc communications network, transmits second change data which specify a change.

In accordance with one exemplary embodiment of the invention, a method for transmitting change information in accordance with the communications device described above is provided.

In accordance with a further exemplary embodiment of the invention, a communications terminal is made available having a memory device which stores utilization data which describe the setting of the communications terminal within the scope of the use of an ad hoc communications network, a receiver device which, by means of the ad hoc communications network, receives change data which specify a change in the utilization data, and a processing device which changes the utilization data in accordance with the change data.

In accordance with a further exemplary embodiment of the invention, a method is made available for changing utilization data in accordance with the communications terminal described above.

The embodiments of the invention which are described in relation to the communications device apply appropriately also to the communications terminal, the method for transmitting data and the method for changing utilization data.

The communications device illustratively passes on change information, for example for updating the utilization data (which is also referred to below as utilization information), if appropriate after processing and/or buffering, to communications terminals which use the ad hoc communications network. The change may be a necessary change, for example a change in a frequency mask which is necessary owing to new use regulations, or else a useful change which improves the operation of the communications terminal, for example optimization of the utilization data or an error correction.

This is advantageous in particular if the ad hoc communications network is a communications network with small geographic extent, and the communications terminals therefore cannot be reached from a large distance, for example from a central device. The communications device can, on the other hand, easily be reached if the communications network is, for example, a mobile radio communications network or a fixed line network, and can pass on the change data (if necessary also with a time delay) by means of the ad hoc communications network.

If the ad hoc communications network is, for example, a Bluetooth communications network and if the utilization data describe frequency masks for the UWB (Ultra Wide Band) frequency band, the invention permits the frequency masks easily to be adapted, for example in accordance with a change in the permissible transmission powers by a regulating authority. In particular, the effort for manufacturers of Bluetooth modules for adapting the Bluetooth modules to future changes in the maximum permissible transmission powers in the UWB frequency band are kept low, even if the Bluetooth modules have already been installed in communications terminals and are being sold and marketed and are in use. Reasons for necessary updating of the utilization data (utilization information) may be, for example, future decisions of the regulating authorities relating to the permissible or non-permissible UWB frequency ranges or changes in the transmission powers in specific UWB frequency ranges, as has already been explained briefly above.

In addition, it is not necessary for manufacturers of Bluetooth modules to develop different Bluetooth modules in accordance with different frequency masks which are valid, for example, in different regions of the world but instead they can limit themselves to the development of a Bluetooth module which has stored a frequency mask and which is adapted depending on the region in which it is operated. The use of the invention is advantageous in particular in view of the current practice of regulating authorities of defining the maximum permissible transmission powers for the UWB frequency band with varied timing or of postponing decisions about which frequency ranges of the UWB frequency band may be used and which maximum transmission powers are permissible to some indeterminate time.

An ad hoc communications network is understood to be a wireless communications network for networking two or more communications terminals for which no fixed infrastructure is necessary. In particular, an ad hoc communications network can be set up spontaneously between two or more communications terminals. This may occur, for example, automatically whenever two communications terminals are in range of one another. The communications terminals may set up the ad hoc communications network independently, that is to say without a central unit. In other words, the ad hoc communications network is self-configurable. Communications terminals which wish to participate in the ad hoc communications network can be integrated dynamically into the ad hoc communications network. The ad hoc communications network is, for example, a close range communications network for communication in the close surroundings, that is to say the communications terminals which participate in the ad hoc communications network are only a few meters or, for example, up to a maximum of 20 meters, up to a maximum of 50 meters or up to a maximum of 100 meters, from one another.

The ad hoc communications network is, for example, a MANET (Mobile Ad hoc Network) or is configured in accordance with instant infrastructure or mobile mesh networking.

In one embodiment, the communications device additionally has a processing device which generates the second change data from the first change data taking into account properties of the communications terminal.

The communications network can thus serve to condition the first change data, for example the format of the second change data can be selected in such a way that the communications terminal can interpret the second change data.

The communications device can additionally have a memory device which stores the utilization data.

In one embodiment, the communications device has a change device which changes the utilization data stored in the memory device in accordance with the first change data. Thanks to the memory device, the (possibly changed) utilization data can be transmitted with a time delay to the communications terminals which participate in the ad hoc communications network.

The second change data are, for example, the changed utilization data. In this case, it is not necessary for the communications terminal itself to change the utilization data stored in the memory device of the communications terminal in accordance with the second change data but instead it can simply store the changed utilization data.

The first change data have, for example, a time reference, and the communications device has a comparator device which, on the basis of the time reference, checks whether the first change data are more up to date than the utilization data stored in the memory device.

In an analogous fashion, the second change data can have a time reference and the communications terminal can have a comparator device which, on the basis of the time reference, checks whether the second change data are more up to date than the utilization information stored in the memory device.

The time reference in the first and/or second change data can also be used to communicate to the communications device or the communications terminal the time from which or the length for which the change data are valid and are to replace the currently selected utilization information. The time information can consequently either be specified in absolute terms (examples: “valid from Sep. 1, 2005, 14:00 UTC”/“valid to Dec. 31, 2005 18:00 UTC”) or in relative terms (examples: “start of validity: in 12 hours”/“expiry of validity: in 48 hours”).

The utilization data specify, for example, the maximum transmission power to be used for transmitting data within the scope of the ad hoc communications network for at least one frequency. In one embodiment, the utilization data define the maximum transmission power to be used for transmitting data within the scope of the ad hoc communications network for frequencies of a frequency band. The frequency band is, for example, the UWB (Ultra Wide Band) frequency band, in particular the UWB frequency band in accordance with the WiMedia standard in the range from 3.1 GHz to 10.6 GHz. In another embodiment, the utilization data specify, for example, the maximum transmission power to be used for transmitting data within the scope of the ad hoc communications network for at least one defined frequency band group within the UWB frequency band in accordance with the WiMedia standard.

The utilization data can, for example, also be a Firmware for a communications terminal which controls the use of the ad hoc communications network. Accordingly, the change may comprise an update of the Firmware.

In particular, the utilization data can, within the scope of a Firmware update, relate to a change in the parts of the MAC (Medium Access Control) layer implemented in the software or the parts of the HCI (Host Controller Interface) implemented in the software.

The communications device is, for example, a (locally) permanently installed communications terminal or a mobile communications terminal. The communications network is, for example, a fixed line network or a mobile radio communications network.

The first change data and/or the second change data are configured in one embodiment in accordance with XML (eXtensible Markup Language). Other embodiments are likewise possible and are not excluded.

The ad hoc communications network is, for example, a Bluetooth communications network or a ZigBee communications network.

Bluetooth communications networks, that is to say communications networks in accordance with the Bluetooth standard, usually have an ad hoc character, that is to say electronic devices which are set up for use of the Bluetooth technology and are brought in range of one another, find one another automatically and spontaneously and form a communications network automatically in accordance with Bluetooth. A communications network in accordance with Bluetooth is also referred to as a WPAN (Wireless Personal Area Network). A Bluetooth device, that is to say a communications device, which is set up for use of the Bluetooth technology, can simultaneously have up to seven communications links to other Bluetooth devices. The available bandwidth is divided between the communications links. A Bluetooth communications network, that is to say a communications network in accordance with Bluetooth, is also referred to as a Bluetooth piconet.

A Bluetooth communications link, that is to say a communications link in accordance with Bluetooth, between two Bluetooth devices, can be used both to transmit voice data and other data. The encryption of the transmitted data is also supported.

Communications devices which are set up for use of the Bluetooth technology are equipped with a microchip, referred to as the Bluetooth module, which makes available the fundamental functionalities for operating Bluetooth communications links. The Bluetooth module has low energy requirements, makes available integrated security measures, and is relatively cost-effective to manufacture. It can thus be used in a wide range of electronic communications devices.

A Bluetooth module has a radiofrequency component and a baseband control device. The baseband control device (baseband controller) forms the interface with the host system, that is to say with the electronic communications device, in which the Bluetooth module is used, for example a PC, a laptop or a mobile phone.

In accordance with the Bluetooth standard, three transmission power classes are defined: 1 mW (0 dBm) 2.5 mW (4 dBm) and 100 mW (20 dBm) which permit a range of communications links of 10 m to 100 m, as represented in table 1.

TABLE 1
Bluetooth power classes

| | Maximum | Minimum range |
|---|---|---|
| Class | Transmission power | for line of sight connection |
| 1 | 100 mW/20 dBm | 100 m |
| 2 | 2.5 mW/4 dBm | 20 m |
| 3 | 1 mW/0 dBm | 10 m |

The power consumption of Bluetooth modules is comparatively low: it is approximately 0.3 mA in the standby mode and reaches a maximum of 140 mA in other modes. During reception, a Bluetooth module has a sensitivity of at least −70 dBm and the channel width used is 1 mHz. Bluetooth devices currently use the license-free ISM (Industrial, Scientific, Medical) frequency band for communications links. The ISM frequency band is between 2.402 GHz and 2.480 GHz and may be operated without approval throughout the world. Bluetooth communications links which are made available by means of the ISM frequency band can experience interference from WLAN (Wireless Local Area Network) communications networks, cordless (fixed line network) telephones, garage door openers and microwave ovens since these also emit electromagnetic waves in the ISM frequency band.

With Bluetooth, a degree of robustness with respect to interference is achieved by virtue of the fact that a frequency hopping method is used in which the ISM frequency band is divided into 79 frequency stages with spacing of 1 MHz and during radio transmission changes are made between the frequency stages up to 1600 times per second. Guard bands are provided at adjacent frequency ranges.

With version 1.2 of Bluetooth (and in older versions), it is theoretically possible to achieve a data transmission rate of 723.2 Kbit/s when downloading (that is to say net data transmission rate during downloading) with a simultaneous data transmission rate of 57.6 Kbit/s when uploading (that is to say net data transmission rate during uploading). With version 2.0 of Bluetooth an optional extension is provided which is known by the name EDR (Enhanced Data Rate) and it permits a maximum data transmission rate which is approximately three times as high, that is to say approximately 2.2 Mbit/s (net data transmission rate during downloading).

The theoretical ranges of Bluetooth devices which are specified in table 1 depending on the power class can be increased at low effort so that a mobile phone which is set up to use the Bluetooth technology and, for example, a Bluetooth communications link to a personal computer which is equipped with a modified Bluetooth USB (Universal Serial Bus) dongle with a directional radio antenna can be at a distance of 1.5 km from one another given a line of sight contact.

If a Bluetooth device is activated, the Bluetooth controller which is provided in the Bluetooth module of the Bluetooth device identifies itself by transmitting an individual and unique 48 bit-long serial number within 2 seconds. If a Bluetooth device is in the standby mode without a communications link to another Bluetooth device, it checks every 1.28 seconds whether another Bluetooth device is emitting messages (at 32 frequency levels). A Bluetooth device can initiate a communications link to another Bluetooth device and thus make itself a master. The contact of other Bluetooth devices from the master Bluetooth device (that is to say to slaves) is respectively established by means of an inquiry message and a following page message if the hardware address of the respective other Bluetooth device is not known. If the hardware address of a Bluetooth device is known, the master does not send an inquiry message to the Bluetooth device. After 16 identical page messages have been sent at 16 different (hopping) frequencies to the slaves by the master, the master and the slaves are in the “connected” status. This status is reached on average within 0.6 seconds after the Bluetooth devices are switched on.

The master can place the slaves in a hold mode to save current if no data is being transmitted at a particular time. Further states for saving current which are especially suitable for application in mobile terminals, such as for example a mobile radio telephone, are the SNIFF mode and the PARK mode. In the SNIFF mode, a slave operates with a reduced cycle, while in the PARK mode a Bluetooth device remains synchronized but does not participate in the data traffic.

Data is transmitted in Bluetooth by using a combination of line switching and packet switching. Two different connection types are provided.

Synchronous Connection Oriented (SCO)

The communication using SCO (synchronous connection oriented communication) implements a symmetrical, line-switched point-to-point communications link between a master and a slave. The master reserves timeslots for the data transmission at regular time intervals. The master can transmit data to the slave in a fixed timeslot, a so-called SCO interval which is referred to as TSCO, and the slave can transmit data to the master in the following timeslot. A master can have up to three SCO communications links simultaneously to one or more slaves. A slave can have up to three SCO communications links simultaneously to the same master or up to two SCO communications links simultaneously to different masters. SCO communications links are aimed at permitting efficient transmission of voice data. By means of an SCO communications link it is possible to transmit voice data at 64 kbit/s. In the case of SCO communications links there is no checking of the data integrity. If data is lost during the transmission, no renewed transmission takes place since as a result delays in the transmission of the data to be subsequently transmitted would occur. CVSD (Continuous Variable Slope Delta) modulation is typically used to encode voice data. The CVSD modulation is a type of delta modulation in which the step size of a signal is continuously increased or reduced in order to adapt the signal as satisfactorily as possible to an analog input signal. During the implementation, only the changes (that is to say an increase or a reduction) compared to a previous value is indicated by means of a bit. CVSD modulation typically operates with a sampling rate of 32 kHz. There are also implementations in which operations are carried out with a lower sampling rate.

Asynchronous Connectionless (ACL)

In ACL communication, a connectionless, packet-switched communications service is provided. An ACL communications link can be used on a channel whenever the channel is not reserved for an SCO communications link (that is to say SCO has priority over ACL). Only one ACL communications link can be set up at any time between a master and a slave. Within the scope of an ACL communications link, a master can also transmit data packets to all the slaves of the Bluetooth communications network. In order to route a data packet in this way, simply no more specific destination address is specified in the packet head of the data packet. ACL communications links are configured for efficient data transmission. In the transmission of data by means of ACL communications links, great emphasis is placed on the data integrity while less attention is paid to delays which could arise during the data transmission. The transmission duration of a packet can be one timeslot, three timeslots or five timeslots. In all types of data packets with the exception of one, a checksum is provided for protection purposes. In the case of Bluetooth, two methods are additionally provided for forward error correction and one method for automatic transmission repetition (automatic repeat request, ARQ) so that reliable data transmission can be ensured. While an SCO communications link is always symmetrical, that is to say the forward channel and back channel of an SCO communications link always have the same bandwidth, an ACL communications link can be either symmetrical or asymmetrical. An overview of possible SCO communications links is given in table 2, and an overview of possible ACL communications links is given in table 3.

TABLE 2
Overview of SCO communications links

| | | | | | Maximum |
|---|---|---|---|---|---|
| | Header | | | | symmetrical |
| | lengths | Useful data | | | data rate |
| Type | [bytes] | [bytes] | FEC | CRC | [kbit/s] |
| HV1 | n.a. | 10 | 1/3 | Yes | 64.0 |
| HV2 | n.a. | 20 | 2/3 | Yes | 64.0 |
| HV3 | n.a. | 30 | No | Yes | 64.0 |
| DV | 1 D | 10⁺ (0-9) D | 2/3 D | Yes | 64.0 + 57.6 D |
| EV3 | n.a. | 1-30 | No | Yes | 96.0 |
| EV4 | n.a. | 1-120 | 2/3 | Yes | 192.0 |
| EV5 | n.a. | 1-180 | No | No | 288.0 |

TABLE 3
Overview of ACL communications links

| | | | | | | Maximum | Maximum |
|---|---|---|---|---|---|---|---|
| | | | | | Maximum | asymmetrical | asymmetrical |
| | Header | Useful | | | symmetrical | data rate | data rate |
| | length | data | | | data | (Uplink) | (Downlink) |
| Type | [bytes] | [bytes] | FEC | CRC | rate [kbit/s] | [kbit/s] | [kbit/s] |
| DM1 | 1 | 0-17 | 2/3 | Yes | 108.8 | 108.8 | 108.8 |
| DH1 | 1 | 0-27 | No | Yes | 172.8 | 172.8 | 172.8 |
| DM3 | 2 | 0-121 | 2/3 | Yes | 258.1 | 387.2 | 54.4 |
| DH3 | 2 | 0-183 | No | Yes | 390.4 | 585.6 | 86.4 |
| DM5 | 2 | 0-224 | 2/3 | Yes | 286.7 | 477.8 | 36.3 |
| DH5 | 2 | 0-339 | No | Yes | 433.9 | 723.2 | 57.6 |
| AUX1 | 1 | 0-29 | No | No | 185.6 | 185.6 | 185.5 |

A time-division multiplex method is used for the duplex data transmission both in SCO communications links and in ACL communications links. As a result, two or more information streams can be transmitted by means of the same communications link by assigning separate timeslots to each information stream. For data packets which are to be transmitted synchronously, specific time intervals can be reserved and each of the data packets is transmitted by means of its own (hopping) frequency.

The ISO (International Organization for Standardization) has defined a reference model for describing manufacturer-independent communications systems which is composed of seven layers and which is referred to as the ISO/OSI model. The ISO/OSI model is used to describe communication between different network devices from different manufacturers. OSI stands here for open system for communications links (Open System Interconnection). Most freely usable network protocols are based on this reference model, for example TCP/IP (Transport Control Protocol/Internet Protocol). The seven levels of the ISO/OSI model are defined in such a way that they build one on the other and the units of one level can be used independently of the units of another level. The units of levels 1 to 4 form the transport system, that is to say in levels 1 to 4 the communications channels are defined physically and logically, and the units of levels 5 to 7 form the application system and serve predominantly for representing information. The seven levels of the ISO/OSI model are referred to, in their sequence from 1 to 7, as the physical layer, connection layer, network layer, transport layer, session layer, presentation layer and application layer.

The physical layer is referred to in Bluetooth as the radio layer. The connection layer is referred to in Bluetooth as the baseband layer, and the network layer is referred to in Bluetooth as the link management layer. The units of the physical layer, the connection layer and the network layer in Bluetooth are frequently combined under the designation Bluetooth controller. The units of the transport layer, which are above the Bluetooth controller in terms of the layer division, are terminated by the optional HCI (Host Controller Interface) in the direction of the higher layers. The HCI serves, in terms of the Bluetooth architecture, as a service access point to the Bluetooth controller. The session layer, which is referred to in Bluetooth as the L2CAP (Logical Link Control and Adaptation Protocol) is above the transport layer. The units of the session layer are required only for ACL communications links, but not for SCO communications links.

The strict division of the ISO/OSI model is not always maintained in real communications systems. For example, in the Bluetooth architecture, parts of the network layer extend into the transport layer. Interoperability in Bluetooth is ensured by the fact that, on the one hand, a clearly defined interface between the Bluetooth controller and the Bluetooth host, that is to say in units of the layers from L2CAP and above is defined, specifically the HCI interface, and that the exchange of protocol messages between units from the same layers of two different Bluetooth systems (for example different communications terminals which communicate with one another by means of Bluetooth) is clearly defined.

The Bluetooth SIG (Bluetooth Special Interest Group) which is concerned with the standardization of the Bluetooth technology defines, in addition to the abovementioned types of communications links, also application profiles which are referred to as Bluetooth profiles and which are intended to permit Bluetooth devices from different manufacturers to cooperate.

In one application profile, both rules and protocols for a dedicated application scenario are defined. An application profile can be considered to be a vertical section through all the protocol layers since the obligatory protocol components are defined for each protocol layer or application profile-specific parameters are defined for each protocol layer. In this way, a high degree of interoperability can be ensured. By using application profiles, a user has the advantage that he does not have to match two or more Bluetooth devices to one another manually. A plurality of application profiles can be used simultaneously. In table 4, an overview of a number of important application profiles is given. The most important application profile is the generic access profile (GAP) which permits fundamental functionalities for setting up communications links for authentication and on which all the other application profiles are based.

TABLE 4
Bluetooth application profiles

| Abbreviation | Profile | Application |
|---|---|---|
| GAP | Generic Access Profile | Fundamental method for |
| | | authentication links and setting up |
| | | connections |
| A2DP | Advanced Audio Distribution Profile | Wireless stereo connection for |
| | | loudspeakers or headsets |
| SDAP | Service Discovery Application | Service interrogation of neighbors |
| | Profile | which can currently be seen |
| CIP | Common ISDN Access Profile | ISDN/CAPI interface |
| PAN | Personal Area Network | Network link to Ethernet |
| SPP | Serial Port Profile | Serial interface |
| DUNP | Dial-Up Networking Profile | Internet access |
| CTP | Cordless Telephony Profile | Cordless telephony |
| HSP | Headset Profile | Cordless headset |
| HCRP | Hardcopy Cable Replacement Profile | Printing |
| HID | Human Interface Device | Keyboard and mouse connection |
| | | (man-machine interface) |
| GOEP | Generic Object Exchange Profile | Object exchange |
| HFP | Hands Free Profile | Manufacturer-independent |
| | | communication between mobile |
| | | phone and hands free device |
| FTP | File Transfer Profile | File transfer |
| BIP | Basic Imaging | Image transmission |
| BPP | Basic Printing | Printing |
| FaxP | Fax Profile | Fax |
| IntP | Intercom Profile | Radio telephony |
| PAN | Personal Area Network | Wireless connection to Ethernet |
| | | (LAN) |
| OPP | Object Push Profile | Transmission of e.g. deadlines and |
| | | addresses |
| SAP | SIM Access Profile | SIM card access |
| GAVDP | Generic AV Distribution | Audio and video transmission |
| AVRCP | Audio Video Remote Control | Audio/video remote control |
| ESDP | Extended Service Discovery Profile | Extended service discovery |
| SP | Synchronization Profile | File synchronization |

Exemplary embodiments of the invention are represented in the figures and will be explained in more detail in the text which follows.

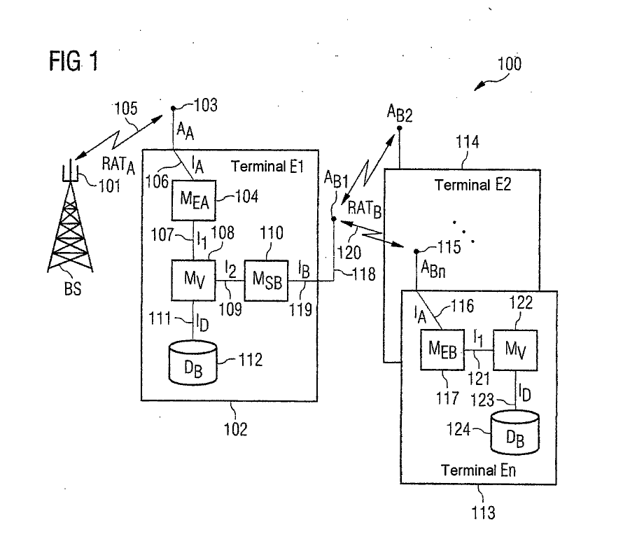

FIG. 1 shows a communications arrangement 100 in accordance with an exemplary embodiment of the invention.

The communications arrangement 100 has a base station 101 of a mobile radio network and a mobile radio subscriber device 102. The mobile radio subscriber device 102 is equipped with a mobile radio antenna 103 and a first Bluetooth module 110 which is coupled to a first Bluetooth antenna 118. The base station 101 can, by means of a mobile radio air interface 105, transmit data to the mobile radio subscriber device 102 which receives the data by means of the mobile radio antenna 103 and the mobile radio module 104. The mobile radio antenna 103 and the mobile radio module 104 are coupled by means of a first internal interface 106.

The mobile radio network is, for example, configured in accordance with the GSM (Global System for Mobile Communications) mobile radio standard, the GPRS (General Packet Radio Services) mobile radio standard, the UMTS (Universal Mobile Telecommunications Standard) mobile radio standard, the EDGE (Enhanced Data Rates for GSM Evolution) mobile radio standard or in accordance with the CDMA2000 mobile radio standard (CDMA: Code Division Multiple Access).

In another embodiment of the invention, the mobile radio subscriber device 102 is a fixed line network telephone, and correspondingly the base station 101 is a unit of a fixed line network, the first air interface 105 is a fixed line network interface and the mobile radio module 104 is a fixed line network module.

The mobile radio module 104 is connected to a first comparator device 108 by means of a second internal interface 107. The first comparator device 108 is connected to the Bluetooth module 110 by means of a third internal interface 109. In addition, the first comparator device 108 is connected by means of a fourth internal interface 111 to a first database 112 which is implemented, for example, by means of a flash memory of the mobile radio subscriber device 102. The first comparator device 108 can carry out reading and writing access operations to the first database 112 by means of the fourth internal interface 111.

The communications arrangement can additionally have a communications terminal 113. It is possible for there to be further communications terminals 114 present. However, in the text which follows reference is made to the communications terminal 113 as an example.

The communications terminal 113 has a second Bluetooth antenna 115 which is connected by means of a fifth internal interface 116 to a second Bluetooth module 117 of the communications terminal 113. By means of the first Bluetooth module 110 and the first Bluetooth antenna 118, which are connected to one another by means of a sixth internal interface 119, the mobile radio subscriber device 102 can transmit data by means of a second air interface 120 to the communications terminal 113 and the communications terminal 113 can receive said data by means of the first Bluetooth antenna 115 and the Bluetooth module 117.

The second Bluetooth module 117 is connected to a second comparator device 122 by means of a seventh internal interface 121. The second comparator device 122 is connected by means of an eighth internal interface 123 to a second database 124 which is implemented, for example, by means of a flash memory of the communications terminal 113.

The mobile radio antenna 103, the first Bluetooth antenna 118 and the second Bluetooth antenna 115 can be configured either as internal or external antennas.

The first Bluetooth module 110 and the second Bluetooth module 117 are configured in such a way that data can be transmitted by means of the second air interface 120 both by using the currently customary Legacy Bluetooth Wireless Technology transmission technology which operates in the approval-free ISM (Industrial, Scientific, Medical) frequency band at frequencies around 2.4 GHz and by means of one of the transmission technologies whose use is currently being discussed within the scope of Bluetooth and which operate in the UWB (Ultra Wide Band) frequency band and are based on OFDM (Orthogonal Frequency Division Multiplexing) or DSSS (Direct Sequence Spread Spectrum).

The mobile subscriber device 102, the communications terminal 113 and the further communications terminals 114 form a Bluetooth piconet.

In the second database 124, utilization information about the use of the second air interface 120 is stored, in this case a data item relating to the permissible transmission power for all the frequencies of the UWB frequency band. On the basis of this utilization information, the communications terminal 113 uses the second air interface 120. The communications terminal 113 can send data to, for example, the further communications terminals 114 by using the second Bluetooth module 117 and the second Bluetooth antenna 115. This is also done on the basis of the utilization information stored in the second database 124.

In an analogous fashion, utilization information on the basis of which the mobile radio subscriber device 102 utilizes the Bluetooth transmission technology is stored in the first database 112.

By means of the first air interface 105, the base station 101 transmits update information (which is also referred to as change data) to the mobile radio subscriber device 102. The update information is information relating to the updating of the utilization information stored in the first database 112 and in the second database 124.

Both the update information and the utilization information stored in the first database 112 and the utilization information stored in the second database 124 has, in one embodiment, a time stamp and an authentication feature.

By using the time stamp, the first comparator device 108 checks whether the update information is more up to date than the utilization information stored in the first database 112. By using the authentication feature of the update information, the mobile radio subscriber device 102 can also determine whether the update information originates from a reliable source. It is assumed below that the update information is more up to date than the utilization information stored in the first database 112 and that the update information originates from a reliable source.

The update information can be transmitted from the base station 101, for example in the form of one or more push messages, in the form of one or more multimedia messages or in the form of USSD (Unstructured Supplementary Service Data) to the mobile radio subscriber device 102 and also configured in the form of update commands.

By using the update information, the mobile radio subscriber device 102 updates the utilization information stored in the first database 112. The updated utilization information is stored in the first database 112 and transmits to the communications terminal 113 by means of the second air interface 120. The Bluetooth module 110 can also have a conditioning device in this context and can adapt the updated utilization information to the requirements of the communications terminal 113, for example convert it to a specific format or generate an update command which is transmitted to the communications terminal by means of the second air interface 120. The second comparator device 122 checks whether the updated utilization information which has been transmitted to the communications terminal 113 from the mobile radio subscriber device 102 is more up to date than the utilization information stored in the second database 124 and checks the updated utilization information for authenticity. If the updated utilization information has been authenticated and if it is more up to date than the utilization information stored in the second database 124, the utilization information stored in the second database 124 is correspondingly updated.

In one exemplary embodiment, the transmission of the updated utilization information by means of the second air interface 120 takes place in the approval-free ISM frequency band (at 2.4 GHz) using the Legacy Bluetooth Wireless Technology transmission technology.

The update information can be, for example, a complete frequency mask for the entire UWB frequency band, that is to say a data item relating to the permissible maximum transmission power for each frequency of the UWB frequency band, or else only contain change information for specific frequencies in the UWB frequency band for which the permissible maximum transmission power has changed. In addition, the update information can also comprise a Firmware update for the use of the ad hoc communications network, for example in order to bring about an update of the parts implemented in the software in the MAC layer and/or in the HCI interface.

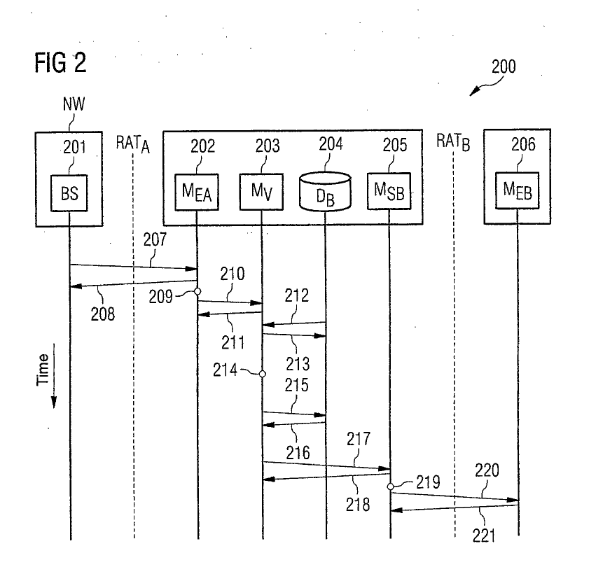

In the text which follows, an example of an update sequence for the utilization information which is stored in the first database 112 and in the second database 124 is described with reference to FIG. 2.

FIG. 2 shows a message flowchart 200 according to an exemplary embodiment of the invention.

A base station 201, a mobile radio module 202, a comparator device 203, a database 204, a first Bluetooth module 205 and a second Bluetooth module 206 which are arranged and embodied as explained with reference to FIG. 1 are involved in the illustrated message flow, with the comparator device 203 corresponding to the first comparator device 108, and the database 204 corresponding to the first database 112.

The utilization information which is stored in the database 204 may have, for example, the following information:
a frequency band group identifier which identifies a frequency band group in the UWB frequency band, for example using the division of the UWB frequency band in accordance with WiMedia, for example the data item “band group number 2”,
a frequency identifier which identifies a frequency band in the UWB frequency band, for example using the division in accordance with WiMedia, for example the data item “band number 8”,
a lower frequency band limit, for example fₘᵢₙ=3.1 GHz,
an upper frequency band limit fₘₐₓ=10.6 GHz,
a frequency mask, that is to say a specification of the maximum permissible transmission power for each frequency of the frequency range which is specified by the frequency band group identifier, the frequency band identifier, the lower frequency band limit and/or the upper frequency band limit,
a unique identification feature which can be used for later referencing of this set of utilization information,
a reliable time stamp,
a classification feature of the communications terminal which uses the utilization information, and
an authentication feature.

Under certain circumstances it is advantageous to store in the database 204, in addition to each data record of utilization information, also the information relating to whether this data record is currently being used by the communications device to operate the ad hoc communications network.

In step 207, the update information is transmitted, using for example OMA (Open Mobile Alliance) Device Management or OMA Multimedia Messaging Service, from the base station 201 to the mobile radio subscriber device 102 which receives the update information by means of the mobile radio module 202. The error-free reception of the update data is confirmed to the base station 201 in step 208. In step 209, the mobile radio module 202 analyzes the received update data and detects that the data (or commands) for updating the utilization information are stored in the database 204 and relate to the use of Bluetooth. In step 210, the mobile radio module 202 forwards the received update data to the comparator device 203 which confirms the reception in step 211.

By means of the second internal interface, in steps 212 and 213 the comparator device 203 reads out the utilization information stored in the database 204 and/or determines the time stamp of the utilization information stored in the database 204.

The comparator device 203 uses the time stamp of the utilization information stored in the database 204 and the time stamp of the update information to check whether the update information is more up to date than the utilization information stored in the database 204. In addition, the comparator device 203 uses the authentication feature of the update data to check whether the update data have been transmitted from a reliable source to the mobile radio subscriber device 102. The comparator operations which are necessary for this are carried out in step 214.

If it is determined that the update information is more up to date than the utilization information stored in the database 204 and that the update information originates from a reliable source, the utilization information stored in the database 204 is correspondingly updated and stored in the database 204 in the steps 215 and 216. The obsolete utilization information can be overwritten here or else remains stored in the database 204 for possible later use.

The update information is then transmitted in step 217 to the first Bluetooth module 205 which confirms its reception in step 218. As mentioned, the first Bluetooth module 205 can also have a conditioning device which adapts the update information in step 219 to the requirements of the communications terminal 113, for example converts it into a suitable instruction format or adapts the update information to the properties of the second air interface 120.

In step 220, the update information is transmitted from the first Bluetooth module 205 to the communications terminal 113 which receives the update information by means of the second Bluetooth module 206 and confirms the reception in step 221.

The update information which is, if appropriate, conditioned by the conditioning device can be transmitted to the communications terminal 113 or else the utilization information which is updated by the comparator device 203 can be transmitted. Accordingly, the second comparator device 122 of the communications terminal 113 itself updates the utilization information stored in the second database 124 using the update information or simply stores the updated utilization information in the second database 124 if said utilization information has been transmitted from the mobile radio subscriber device 102 to the communications terminal 113.

As mentioned above, the update information or the updated utilization information is transmitted in this exemplary embodiment from the mobile radio subscriber device 102 to the communications terminal 113 using the license-free ISM frequency band in accordance with version 2.0 (or lower) of the Bluetooth standard. The update information (or updated utilization information) can be transmitted, for example, by means of the Object Push Profile (OPP) application profile. It is also possible to define a new Bluetooth application profile for the transmission of the update information or of the updated utilization information.

In the communications terminal 113, analogous steps to the steps 209 to 216 are carried out by the second Bluetooth module 117, the second comparator device 122 and the second database 124 so that the updated utilization information is ultimately also stored in the second database 124 and the communications terminal 113 uses Bluetooth correctly according to the current prescriptions.

In the exemplary embodiment described above, the updating of the utilization information stored in the first database 112 and the second database 124 started from the mobile radio network. Likewise, the mobile radio subscriber device 102 can initiate the updating process by sending a request for the update information to the mobile radio communications network. Likewise, the communications terminal 113 can transmit a request for update information by means of the second air interface 120 and the second Bluetooth module 117 to the mobile radio subscriber device 102, in response to which the mobile radio subscriber device 102 transmits a request for change information to the mobile radio network.

In the embodiment described above, update information is distributed by a mobile radio subscriber device to one or more communications terminals by means of a Bluetooth air interface. In the text which follows, an exemplary embodiment is described in which this is not carried out by a mobile radio subscriber device but rather by a permanently installed device.

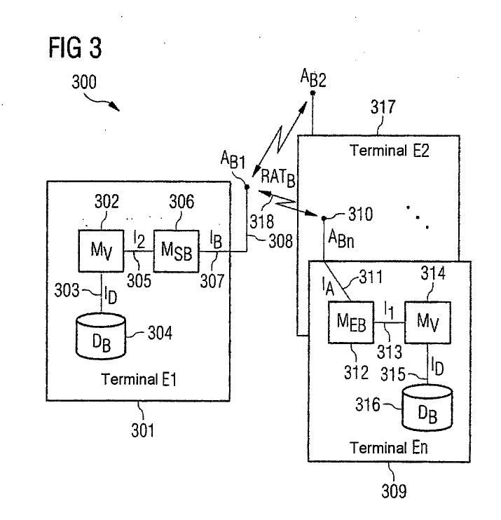

FIG. 3 shows a communications arrangement 300 in accordance with an exemplary embodiment of the invention.

The communications arrangement 300 has a first communications terminal 301 which, in contrast to the mobile radio subscriber device 102, is a permanently installed device, for example a device which is permanently mounted in an airport building or in a hospital. Correspondingly, the communications terminal 301 does not have a mobile radio antenna or a mobile radio module but, like the mobile radio subscriber device 102, has a first comparator device 302 which is connected by means of a first internal interface 303 to a first database 304 and is connected by means of a second internal interface 305 to a first Bluetooth module 306 which, in an analogous fashion to the above, can have a conditioning device and is connected to a first Bluetooth antenna 308 by means of a third internal interface 307.

The communications arrangement 300 also has a second communications terminal 309 which corresponds to the communications terminal 113 in FIG. 1 and is configured in an analogous fashion to it with a second Bluetooth antenna 310 which is connected by means of a fourth internal interface 311 to a second Bluetooth module 312 which itself is connected to a second comparator device 314 by means of a fifth internal interface 313. The comparator device 314 is connected to a second database 316 by means of a sixth internal interface 315.

The communications arrangement can, like the communications arrangement 100 described with reference to FIG. 1, have further communications terminals 317.

In an analogous fashion to the exemplary embodiment described with reference to FIG. 1 and FIG. 2, utilization information is stored in the first database 304 and in the second database 316. Data can be transmitted from the first communications terminal 301 to the second communications terminal 309 by means of an air interface 318.

The first communications terminal 301, the second communications terminal 309 and the further communications terminals 317 are configured to transmit and receive data using Bluetooth both by means of the currently conventional Legacy Bluetooth Wireless Technology transmission technology in the approval-free ISM frequency band (around 2.4 GHz) and by means of transmission technologies which operate in the UWB frequency band. The utilization information which is stored in the first database 304 and in the second database 316 is information which is necessary to use Bluetooth, for example frequency masks for the UWB frequency band (between 3.1 GHz and 10.6 GHz).

As soon as the second communications terminal 309 and possibly the further communications terminals 317 are moved into the transmission and reception range of the fixedly installed communications terminal 301, a communications link is set up between the first communications terminal 301 and the second communications terminal 309, and possibly between the communications terminal 301 and the further communications terminals 317.

In the text which follows, a sequence is described for the interrogation of update information for updating the utilization information stored in the second database 316 by means of the second terminal 309 from the first terminal 301.

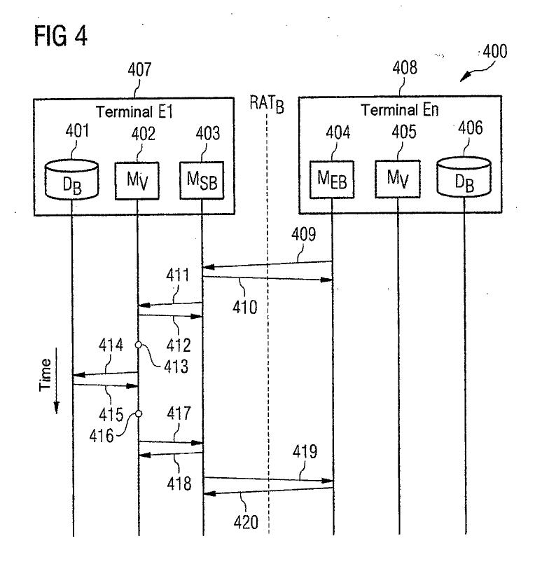

FIG. 4 shows a message flowchart 400 in accordance with an exemplary embodiment of the invention.

The message flow which is illustrated takes place between a first database 401, a first comparator device 402, a first Bluetooth module 403, a second Bluetooth module 404, a second comparator device 405 and a second database 406 which are arranged and configured as explained with reference to FIG. 3.

Accordingly, the first database 401, the first comparator device 402 and the Bluetooth module 403 are part of a first communications terminal 407 (corresponds to 301 in FIG. 3), and the Bluetooth module 404, the second comparator device 405 and the second database 406 are part of a second communications terminal 408 (corresponds to 309 in FIG. 3).

In step 409, the second communications terminal 408 transmits a request for update information for updating the utilization information stored in the second database 406 to the first communications terminal 407. The correct reception of the request is confirmed to the second communications terminal 408 in step 410. The request is transmitted using, for example, the Object Push Profile (OPP) application profile. However, a separate Bluetooth application profile can also be defined for transmitting the request and all the further transactions illustrated in FIG. 4.

The request has, for example, the following parameters:
a frequency band group identifier which identifies a frequency band group in the UWB frequency band, for example using the division of the UWB frequency band in accordance with WiMedia, for example the data item “band group number 2”,
a frequency identifier which identifies a frequency band in the UWB frequency band, for example using the division in accordance with WiMedia, for example the data item “band number 8”,
a lower frequency band limit, for example fₘᵢₙ=3.1 GHz,
an upper frequency band limit fₘₐₓ=10.6 GHz,
a frequency mask, that is to say a specification of the maximum permissible transmission power for each frequency of the frequency range which is specified by the frequency band group identifier, the frequency band identifier, the lower frequency band limit and/or the upper frequency band limit,
a unique identification feature which can be used for later referencing of this set of utilization information,
a reliable time stamp,
a classification feature of the communications terminal, and
an authentication feature
   or else just have a reference to a set of parameters of this kind if the first communications terminal 407 is capable of resolving references to such parameter sets, that is to say of determining the referenced set of parameters from a received reference. If the request contains such a parameter set, it is transmitted from the first Bluetooth module 403 in step 411 to the first comparator device 402 which confirms the reception in step 412. If the request only contains a reference to a parameter set, the latter is passed on accordingly to the comparator device 402 in step 411.

If only a reference to a data record has been transmitted to the comparator device 402, the latter resolves the reference by, for example, an access to the first database 401 in step 413.

In all cases, after the step 413 (carried out only in the case of the transmission of a reference), the comparator device 402 has a set of parameters available, which reflects the utilization information stored in the second database 406.

In step 414, the comparator device 402 requests, from the first database 401, the utilization information stored there and/or the time stamp of the utilization information stored in the first database 401. In step 415, the first database 401 accordingly transmits the utilization information stored in the first database 401 and/or the time stamp of the utilization information stored in the first database 401 to the first comparator device 402.

By means of a comparison of the time stamp of the utilization information stored in the database 401 and the time stamp of the utilization information stored in the second database 406, which is contained in the parameter set, the first comparator device 402 determines, in step 416, whether the utilization information stored in the first database 401 is more up to date than the utilization information stored in the second database 406. In this case, the utilization information stored in the first database 401 is transmitted, in the steps 417 and 418 (reception confirmation) from the comparator device 402 to the Bluetooth module 403 which transmits the utilization information on to the Bluetooth module 404 in the steps 419 and 420 (reception confirmation).

The utilization information stored in the first database 401 can in this way be transmitted completely to the second communications terminal 408, specifically also in the form of change information or change commands, or the parameter set which has been transmitted from the second communications terminal 408 to the first communications terminal 407 (if appropriate only in the form of a reference) can be updated in accordance with the utilization information stored in the first database 401, and the parameter set which is updated in this way can be transmitted to the second communications terminal 408. In addition, a reference to a parameter set which is stored in the second database 406 and which corresponds to the updated parameter set can be transmitted. Such a reference can, for example, be resolved by means of the second comparator device 405. The utilization information stored in the second database 406 is updated by the second comparator device 405 in accordance with the update information which has been transmitted to the second communications terminal 408 (corresponds to 309 in FIG. 3) from the first communications terminal 407 (corresponds to 301 in FIG. 3) (in any form).

During the further use of Bluetooth, the second communications terminal 309 takes into account the updated utilization information stored in the second database 406 until a further update is carried out, for example as described with reference to FIG. 1 or FIG. 2.

Similarly to the exemplary embodiment described with reference to FIG. 1 and FIG. 2, change information can be authenticated, for example by the second comparator device 405 or else the parameter set which is transmitted from the second communications terminal 309 to the first communications terminal 301 can be authenticated by the first comparator device 402.

In the exemplary embodiment described with reference to FIG. 4, the initiative for updating the utilization information stored in the second database 406 came from the second communications terminal 408. In another embodiment, the permanently installed first communications terminal 407 transmits the update information automatically to each mobile communications terminal at which the first communications terminal 407 sets up a Bluetooth communications link. The time for requesting update information (cf. step 409) can be predefined in various ways. For example, a request for update information can be carried out periodically or whenever a specific event occurs. A possible event in which a request for update information is carried out is the registering of the second communications terminal in a Bluetooth piconet, for example after arrival at an airport in another country or in a hospital. A further possible event in which a request for update information is carried out is the determination of the location of the second communications terminal using, for example, the country identifier of a mobile radio network or by means of satellite-supported navigation systems such as GPS (Global Positioning System of the US defense department) or Galileo (European satellite navigation system which is intended to be operational at the end of 2010.

In another embodiment, the first comparator device 108, the first Bluetooth module 110 and/or the first database 112 are provided in a functional unit which is independent of the mobile radio subscriber device 102, for example a chip card (smart card), for example a SIM (Subscriber Identity Module) card if the mobile radio communications network is a GSM mobile radio network, or in a UICC (Universal Integrated Circuit Card) with a USIM (Universal Subscriber Identity Module) if the mobile radio communications terminal is a UMTS mobile radio network. This functional unit can be connected to the mobile radio subscriber device 102 (or else to the permanently installed first communications terminal 301) (for example by plugging in the smart card) so that the devices and modules provided in the functional unit can be used.

Using chip cards such as are provided for mobile radio subscriber devices for mobile radio communications networks, in particular SIM cards or UICCs with USIM, is advantageous since they have memory areas for which only the operator of the mobile radio communications network has writing and reading rights and memory areas for which only the user of the mobile radio subscriber device has writing and reading rights. Memory areas for which only the operator has writing and reading rights are particularly suitable for storage and subsequent OTA (Over the Air) updating of utilization information which relates to approval-compatible operation of an air interface, for example data records which specify UWB frequency masks for the operation of a Bluetooth module.

Tasks within the scope of the updating of utilization information, for example the functionality of a comparator device as described above, can be carried out by applications which are implemented on a chip card, for example on a SIM card using the SAT (SIM Application Tool Kit) or on a UICC using the USAT (USIM Application Tool Kit).

Analogously, the second comparator device 122, the Bluetooth module 117 and/or the second database 124, that is to say units of the communications terminal to which the update information is passed on, can also be provided on an independent functional unit, for example a chip card.

Update information for updating the utilization information stored in the second database 124, 316 or updated utilization information for storage in the second database 124, 316 can be transmitted from the mobile subscriber device 102 or from the first communications terminal 301 entirely in the form of change information which specifies a change compared to the previous state of the utilization information (i.e. only the deviations between two sets of utilization information are transmitted) or in the form of a reference to the communications terminal 113 or to the second communications terminal 309. For example, data is transmitted which contains a specification of UWB frequency masks and it is advantageous to use a uniform, standardized structure for this. For example, in one embodiment the update information, change information or updated utilization information (in the text which follows generally only the term update information is used) is transmitted in the form of messages which are configured in accordance with XML (eXtensible Markup Language). XML is a markup language which is recommended officially as the document processing standard by the W3C (World Wide Web Consortium) both for dynamically generated contents and for static web pages. XML is particularly suitable for platform-independent and software-independent exchange of data between different programs and/or data processing devices from different manufacturers.

The syntax of XML is comparatively strict so that XML applications (definitions of XML instructions for a class of XML documents with the same structure for a specific purpose) can be processed significantly easier, more conveniently and more efficiently by computer programs than, for example, files which are configured in accordance with HTML (Hypertext Markup Language).

An XML document is typically composed of one or more XML elements. Each XML element is composed of two tags which are respectively surrounded by a < character and a > character, with the first tag being a start tag which contains the name of the XML element and the second tag being an end tag which is identical with the start tag apart from a slash before the name, for example:

abstract:
<name>
content
</name>
specific:
<price>
24.95
</price>

### In addition, it is possible to include attributes in an XML element.

abstract:
<name attribute=“value”>
content
</name>
specific:
<price currency=“Euro”>
24.95
</price>

In addition to “normal” XML documents which are typically defined by the use of informative XML elements, there are also XML documents of the category DTD (Document Type Definition) for which separate rules are prescribed for how the XML elements and XML attributes used in these XML documents are defined and the logical relationship they have with one another within the XML document.

In the text which follows, two examples of the specifications of update information are described in the form of XML using a DTD.

In one exemplary embodiment, a plurality of communications terminals in which utilization information for using, for example, Bluetooth, is stored, and correspondingly have to update this utilization information, for example, when there is a change in the permissible frequencies in the UWB frequency band or when there is a change in the maximum permissible transmission powers in the UWB frequency band, use the same DTD which is referred to in this example as “UWB Frequency Mask”, and when necessary can download the latter from the homepage of a regulating authority, which can be addressed, for example, by means of the URL (Uniform Resource Locator)

“http://www.reg_authority.org/dtd/frequ/uwb/id_xyz.dtd”.

According to this DTD, the maximum permissible transmission power is specified in an XML document in order to specify update information for each of the five frequency band groups which are defined in accordance with the UWB standard of the WiMedia Alliance. In addition, a maximum permissible tolerance of the transmission power is specified for each frequency band group. An example of such an XML document is given in table 5.

TABLE 5

```
<?xml version=1.0”>
<!DOCTYPE body PUBLIC “UWB Frequency Mask”
“http://www.reg_authority.org/dtd/frequ/UWB/ID_xyz.dtd”>
<body>
  <authority=“CEPT”/>
  <date=“01.Sep.2005”/>
  <timestamp=“17:00:00CET”/>
  <region=“Europe”/>
  <country=“Germany”/>
  <state=“LowerSaxony”/>
  <signature=“AF3E 5A82 6376 EA87 58AB 78BC CC0C 9110”/>
  <mask ID=“CFM000.018.031.973”/>
  <unit=“dBm/MHz”/>
  <bandgroup number=“1”>
    <max>−70.0</max>
    <tolerance>1.5</tolerance>
  </bandgroup>
  <bandgroup number=“2”>
    <max>−55</max>
    <tolerance>1.0</tolerance>
  </bandgroup>
  <bandgroup number=“3”>
    <max>−40</max>
    <tolerance>0.0</tolerance>
  </bandgroup>
  <bandgroup number=4”>
    <max>−55</max>
    <tolerance>1.0>/tolerance>
  </bandgroup>
  <bandgroup number=“5”>
    <max>−70</max>
    <tolerance<1.5</tolerance>
  </bandgroup>
</body>
```

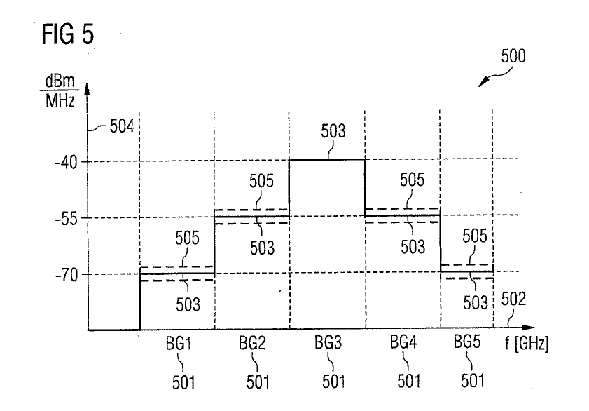

The update information which is specified by the XML document which is illustrated is illustrated in FIG. 5.

FIG. 5 shows a frequency mask 500 in accordance with an exemplary embodiment of the invention.

In the diagram illustrated in FIG. 5, the frequency is plotted to the right along a frequency axis 502 and the maximum transmission power for a frequency is plotted in the upward direction along a transmission power axis 504 in dBm/MHz. As mentioned, each of five frequency band groups 501 (corresponding to a range of frequencies on the frequency axis 502) is assigned a maximum transmission power 503 (corresponding to a value on the transmission power axis 504). For example, the first band group (referred to by BG1 on the far left) is assigned the value −70 dBm (cf. the first “band group” information element in the XML document illustrated above).

In addition, a transmission power tolerance range 505 is defined for each frequency band group 501, that is to say a value by which the maximum permissible transmission power can be exceeded. However, for the third frequency band group 501 (BG3 is designated in FIG. 5), the value 0 is defined as a tolerance (cf. the third “band group” information element in the XML document illustrated above). Accordingly, no transmission power tolerance range 505 is illustrated for the third frequency band group 501 in FIG. 5.

The frequency mask illustrated in FIG. 5 has a step-shaped profile. The first frequency band group 501 (BG1) and the fifth frequency band group 501 (BG5) are assigned the maximum transmission power −70 dBm/MHz, the second frequency band group 501 (BG2) and the fourth frequency band group 501 (BG4) are assigned as maximum transmission power −55 dBm/MHz, and the third frequency band group 501 (BG3) is assigned the maximum transmission power −40 dBm/MHz.

In another exemplary embodiment, the change information is not transmitted as a complete frequency mask by means of an XML document but rather as a reference to a corresponding data record. This reference is configured, for example, as a URL. For example, in an XML document a first URL is specified by means of which a first frequency mask with maximum permissible UWB transmission power can be requested in accordance with the approval regulations of the European Regulating Authority CEPT for the United Kingdom for the operation of communications terminals in the UWB frequency band outside buildings. In addition, for example a second URL is specified by means of which a current valid frequency mask with maximum permissible UWB powers can be requested (and downloaded) in accordance with the approval regulations of the European Regulating Authority CEPT for the United Kingdom for the operation of communications terminals in the UWB frequency band within enclosed buildings. An example of a corresponding XML document is illustrated in table 6.

TABLE 6

```
<?xml version=1.0”>
<!DOCTYPE body PUBLIC “UWB Frenquency Mask”
“http://www.reg_authority.org/dtd/frequ/UWB/ID_xyz.dtd”>
<body>
  <authority=“CEPT”/>
  <date=“01.Okt.2005”/>
  <timestamp=“14:30:00CET”/>
  <region=“Europe”/>
  <country=“UnitedKingdom”/>
  <signature=“084B A974 BE47 D069 F482 68D6 D1F6 A29F 738B
  E99E”/>
  <mask ID=“CFM000.027.121.974”/>
  <unit=“dBm/MHz”/>
  <reference location=“outdoors”>
    <url>
    http://www.cept.org/reg/frequencytables/UWB/UK_002</url>
  </reference>
  <reference location=“indoors”>
  <url>
  http://www.cept.org/reg/frequencytables/UWB/UK_008</url>
  </reference>
</body>
```

The first URL is specified by means of the first “reference” information element, and the second URL is specified by means of the second “reference” information element.

In summary, in one embodiment of the invention a communications device is provided having a receiver device which, by means of a communications network receives first change data which specify the change in utilization data which describe the setting of a communications terminal within the scope of the use of an ad hoc communications network, and a transmitter device which, by means of the ad hoc communications network, transmits second change data which specify the change.

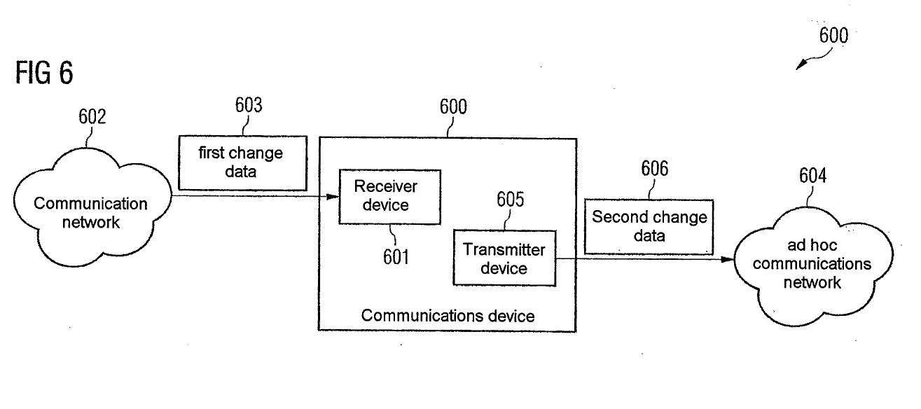

An example of such a communications device is illustrated in FIG. 6.

FIG. 6 shows a communications device 600 according to an exemplary embodiment of the invention.

The communications device 600 has a receiver device 601 which receives first change data 603 by means of a communications network 602. The first change data 603 specify a change in utilization data which describe the setting of a communications terminal within the scope of the use of an ad hoc communications network 604. The communications device 600 additionally has a transmitter device 605 which, by means of the ad hoc communications network 604, transmits the second change data 606 which specify the change.

In accordance with one embodiment of the invention, a communications terminal is provided having a memory device which stores utilization data which describe the setting of the communications terminal within the scope of the use of an ad hoc communications network, a receiver device which, by means of the ad hoc communications network, receives change data which specify a change in the utilization data, and a processing device which changes the utilization data in accordance with the change data.

In a further embodiment of the invention, a communications device is provided having a receiver device which, by means of a communications network, receives first change data which specify a change in utilization data which describe the maximum transmission power when transmitting within the scope of a Bluetooth communications network for frequencies of the UWB frequency band, and a transmitter device which, by means of the Bluetooth communications network, transmits second change data which specify the change.

In accordance with a further embodiment of the invention, a communications terminal is provided having a memory device which stores utilization data which describe the maximum transmission power when transmitting within the scope of a Bluetooth communications network for frequencies of the UWB frequency band, a receiver device which receives change data by means of the Bluetooth communications network which specify a change in the utilization data, and a processing device which changes the utilization data in accordance with the change data.

What is claimed is:

1. A communications device, comprising:
a receiver device configured to receive, via a communications network, first change data specifying a change in utilization data which describe the setting of a communications terminal within the scope of the use of an ad hoc communications network; and
a transmitter device configured to transmit, via the ad hoc communications network, second change data which specify the change.

2. The communications device as claimed in claim 1, further comprising a processing device configured to generate the second change data from the first change data taking into account properties of the communications terminal.

3. The communications device as claimed in claim 1, further comprising a memory device configured to store the utilization data.

4. The communications device as claimed in claim 3, further comprising a change device configured to change the utilization data stored in the memory device in accordance with the first change data.

5. The communications device as claimed in claim 4, wherein the second change data is the changed utilization data.

6. The communications device as claimed in claim 1, wherein the first change data has a time reference, and the communications device further comprises a comparator device configured to check, on the basis of the time reference, whether the first change data are more up to date than the utilization data stored in the memory device.

7. The communications device as claimed in claim 1, wherein the utilization data specifies the maximum transmission power to be used for transmitting data within the scope of the ad hoc communications network for at least one frequency.

8. The communications device as claimed in claim 7, wherein the utilization data defines the maximum transmission power to be used for transmitting data within the scope of the ad hoc communications network for frequencies of a frequency band.

9. The communications device as claimed in claim 8, wherein the frequency band is the UWB frequency band.

10. The communications device as claimed in claim 1, wherein the communications device is a permanently installed communications terminal or a mobile communications terminal.

11. The communications device as claimed in claim 1, wherein the communications network is a fixed line network or a mobile radio communications network.

12. The communications device as claimed in claim 1, wherein the ad hoc communications network is a Bluetooth communications network or a ZigBee communications network.

13. The communications device as claimed in claim 1, wherein the first change data is configured in accordance with XML.

14. The communications device as claimed in claim 1, wherein the second change data is configured in accordance with XML.

15. A method for transmitting data, comprising:
receiving, via a communications network, first change data specifying a change in utilization data describing the setting of a communications terminal within the scope of the use of an ad hoc communications network; and
transmitting, via the ad hoc communications network, second change data specifying the change.

16. A communications terminal, comprising:
a memory device configured to store utilization data describing the setting of the communications terminal within the scope of the use of an ad hoc communications network;
a receiver device configured to receive, via the ad hoc communications network, change data specifying a change in the utilization data; and
a processing device configured to change the utilization data in accordance with the change data.

17. A method for changing utilization data describing the setting of a communications terminal within the scope of the use of an ad hoc communications network, comprising:
receiving, via the ad hoc communications network, change data specifying a change in the utilization data; and
changing the utilization data in accordance with the change data.

18. A communications device comprising:
a receiver device configured to receive, via a communications network, first change data specifying a change in utilization data describing the maximum transmission power when transmitting within the scope of a Bluetooth communications network for frequencies of the UWB frequency band; and
a transmitter device configured to transmit, via the Bluetooth communications network, second change data specifying the change.

19. A communications terminal comprising:
a memory device configured to store utilization data describing the maximum transmission power when transmitting within the scope of a Bluetooth communications network for frequencies of the UWB frequency band;
a receiver device configured to receive, via the Bluetooth communications network, change data specifying a change in the utilization data; and
a processing device configured to change the utilization data in accordance with the change data.

20. A communications device, comprising:
a receiver means for receiving, via a communications network, first change data specifying a change in utilization data which describe the setting of a communications terminal within the scope of the use of an ad hoc communications network; and
a transmitter means for transmitting, via the ad hoc communications network, second change data which specify the change.

21. The communications device as claimed in claim 20, further comprising a processing means for generating the second change data from the first change data taking into account properties of the communications terminal.
